(19) United States
(12) Patent Application Publication
(10) Pub. No.: US 2026/0309042 A1
(43) Pub. Date: Oct. 8, 2026

(54) TURBINE ENGINE COMPONENT WITH A COOLING APERTURE

(71) Applicant: General Electric Company, Evendale, OH (US)

(72) Inventors: Haidong Liu, Weston, MA (US); Kevin R. Feldmann, Mason, OH (US); Chung Han Liou, Lexington, MA (US); Matthew Forrester, North Andover, MA (US); Javier Felipe Jimenez Rincon, Lynn, MA (US)

(21) Appl. No.: 19/098,110

(22) Filed: Apr. 2, 2025

(51) Int. Cl. F02C 7/18

(52) U.S. Cl. CPC F01D 11/005; F01D 11/001; F01D 25/12; F02C 7/18; F05D 2240/11; F05D 2260/201; F05D 2260/232

(57) ABSTRACT

A gas turbine engine including a compressor section, combustion section, and turbine section in serial flow arrangement and defining an engine core that is operationally separated into a rotor that rotates about a rotational axis and a stator that is stationary about the rotational axis. A shroud segment having a forward face and an aft face with a confronting side face extending between the forward face and the aft face. A seal slot provided in the confronting side face with a seal disposed within the seal slot. An air cooling circuit located within the shroud segment, and exhausting to the seal slot.

### TECHNICAL FIELD

The disclosure generally relates to a cooling aperture for a component of a turbine engine.

### BACKGROUND

Turbine engines, and particularly gas or combustion turbine engines, are rotary engines that extract energy from a flow of combusted gases passing through the engine in a series of compressor stages, which include pairs of rotating blades and stationary vanes, through a combustor, and then onto a multitude of turbine blades. In the compressor stages, the blades are supported by posts protruding from the rotor while the vanes are mounted to stator disks. Gas turbine engines have been used for land and nautical locomotion and power generation, as well as for aeronautical applications including aircraft. In aircraft, gas turbine engines are used for propulsion of the aircraft.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic, sectional view of a gas turbine engine with a compressor section, a combustion section, and a turbine section, according to aspects of the disclosure described herein.

FIG. 2 is a schematic, axial view of a blade assembly and a nozzle assembly of the turbine section of FIG. 1 with a shroud segment, according to aspects of the disclosure described herein.

FIG. 3 is an enlarged view of a side face of the shroud segment of FIG. 2, according to aspects of the disclosure described herein.

FIG. 4 is a schematic cross-sectional view of the shroud segment taken along line IV-IV of FIG. 3, according to aspects of the disclosure described herein.

FIG. 5 is a schematic cross-sectional view of the shroud segment taken along line V-V of FIG. 3, according to aspects of the disclosure described herein.

FIG. 6 is a schematic view of a body of a component, according to aspects of the disclosure described herein.

FIG. 7 is a schematic cross-sectional view of the component of taken along line VII-VII of FIG. 6, according to aspects of the disclosure described herein.

### DETAILED DESCRIPTION

One aspect of the disclosure herein is directed to a shroud segment of an annular shroud assembly comprised of multiple shroud segments. The shroud segment includes an air cooling circuit for supplying cooling air to a spline seal between adjacent shroud segments. Supplying air from the air cooling circuit causes a reduction of local temperatures at a side face of the shroud segment and near the edges of the shroud segment, as well as temperature reduction at the spline seal between adjacent shroud segments. Such a reduction in temperature increases and improves component durability and lifetime under high cycle fatigue, which reduces maintenance and related cost.

For purposes of illustration, the present disclosure will be described with respect to a spline seal located within the turbine section for a turbine engine. It will be understood, however, that aspects of the disclosure herein are not so limited and may have general applicability within additional areas of the turbine engine, including but not limited to nozzles, airfoils, combustors, or combustor liners. This disclosure is applicable to other non-aircraft applications or other turbine environments. Non-limiting examples of where this disclosure can be applied include other mobile applications and non-mobile industrial, commercial, and residential applications.

Gas turbine engines for aircraft are designed to operate at high temperatures to maximize engine thrust, so cooling of engine components occurs during operation. Reducing cooling air leakage between adjacent flow path segments in gas turbine engines maximizes efficiency and lowers specific fuel consumption. In adjacent compressor and turbine stages, axial and radial segment gaps create flow paths allowing leakage. Spline seals are used to decrease the leakage between adjacent shroud segments.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine and an outer engine circumference. Furthermore, as used herein, the term “set” or “a set” of elements can be any number of elements, including only one.

Further yet, as used herein, the term “fluid” or iterations thereof can refer to any suitable fluid within the gas turbine engine at least a portion of the gas turbine engine is exposed to such as, but not limited to, combustion gases, ambient air, pressurized airflow, working airflow, or any combination thereof. It is yet further contemplated that the gas turbine engine can be other suitable turbine engine such as, but not limited to, a steam turbine engine or a supercritical carbon dioxide turbine engine. As a non-limiting example, the term “fluid” can refer to steam in a steam turbine engine, or to carbon dioxide in a supercritical carbon dioxide turbine engine.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

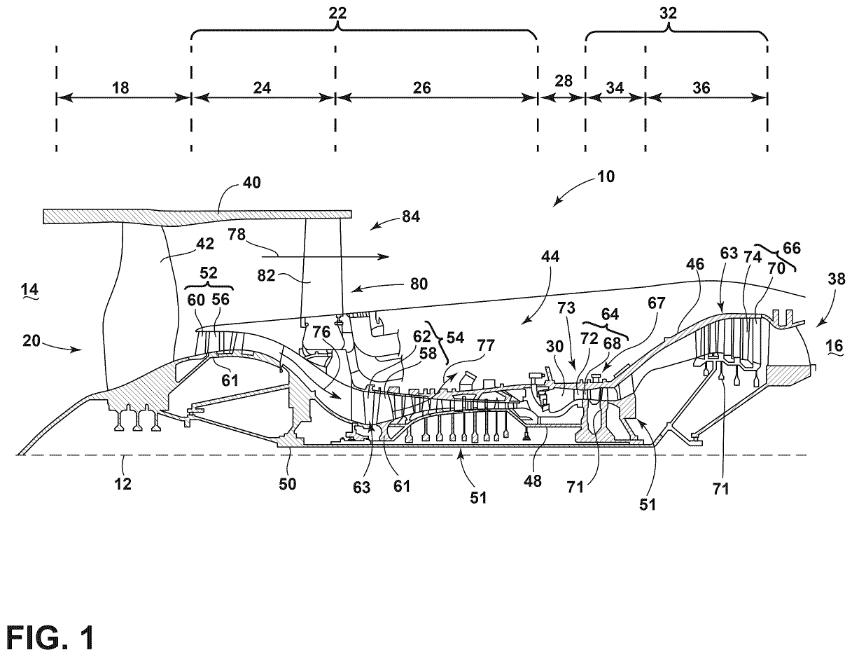

FIG. 1 is a schematic cross-sectional diagram of a turbine engine 10 for an aircraft. However, it should be appreciated that non-aircraft turbine applications are also contemplated and included within the scope of the present disclosure. The turbine engine 10 has a generally longitudinally extending axis or engine centerline 12 extending forward 14 to aft 16. The turbine engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including an HP turbine 34, and an LP turbine 36, and an exhaust section 38.

The fan section 18 includes a fan casing 40 surrounding the fan 20. The fan 20 includes a plurality of fan blades 42 disposed radially about the engine centerline 12. The HP compressor 26, the combustor 30, and the HP turbine 34 form an engine core 44 of the turbine engine 10, which generates combustion gases. The engine core 44 is surrounded by a core casing 46, which can be coupled with the fan casing 40.

An HP shaft or spool 48 disposed coaxially about the engine centerline 12 of the turbine engine 10 drivingly connects the HP turbine 34 to the HP compressor 26. An LP shaft or spool 50, which is disposed coaxially about the engine centerline 12 of the turbine engine 10 within the larger diameter annular HP spool 48, drivingly connects the LP turbine 36 to the LP compressor 24 and fan 20. The spools 48, 50 are rotatable about the engine centerline 12 and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 to compress or pressurize the stream of fluid passing through the stage. In a single compressor stage 52, 54, multiple compressor blades 56, 58 can be provided in a ring and can extend radially outwardly relative to the engine centerline 12, from a blade platform to a blade tip, while the corresponding static compressor vanes 60, 62 are positioned upstream of and adjacent to the rotating compressor blades 56, 58. It is noted that the number of blades, vanes, and compressor stages shown in FIG. 1 were selected for illustrative purposes only, and that other numbers are possible.

The compressor blades 56, 58 for a stage of the compressor can be mounted to (or integral to) a disk 61, which is mounted to the corresponding one of the HP and LP spools 48, 50. The static compressor vanes 60, 62 for a stage of the compressor can be mounted to the core casing 46 in a circumferential arrangement.

The HP turbine 34 and the LP turbine 36 respectively include a plurality of turbine stages 64, 66 that define a blade assembly 67 in which a set of turbine blades 68, 70 are rotated relative to a corresponding set of static turbine vanes 72, 74, also referred to as a nozzle or nozzle assembly 73, to extract energy from the stream of fluid passing through the stage. In a single turbine stage 64, 66, multiple turbine blades 68, 70 can be provided in a ring and can extend radially outwardly relative to the engine centerline 12 while the corresponding static turbine vanes 72, 74 are positioned upstream of and adjacent to the rotating turbine blades 68, 70. It is noted that the number of blades, vanes, and turbine stages shown in FIG. 1 were selected for illustrative purposes only, and that other numbers are possible.

The turbine blades 68, 70 for a stage of the turbine can be mounted to a disk 71, which is mounted to the corresponding one of the HP and LP spools 48, 50. The static turbine vanes 72, 74 for a stage of the compressor can be mounted to the core casing 46 in a circumferential arrangement.

Complementary to the rotor portion, the stationary portions of the turbine engine 10, such as the static vanes 60, 62, 72, 74 among the compressor and turbine sections 22, 32 are also referred to individually or collectively as a stator 63. As such, the stator 63 can refer to the combination of non-rotating elements throughout the turbine engine 10.

In operation, the airflow exiting the fan section 18 is split such that a portion of the airflow is channeled into the LP compressor 24, which then supplies a pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and an exhaust gas is discharged from the turbine engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased above the bleed air temperature. The bleed air 77 may be used to reduce the temperature of the core components downstream of the combustor 30.

A remaining portion of the pressurized airflow 76 bypasses the LP compressor 24 and engine core 44 as a bypass airflow 78 and exits the turbine engine 10 through a stationary vane row, and more particularly an outlet guide vane assembly 80, comprising a plurality of airfoil guide vanes 82, at a fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the turbine engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26

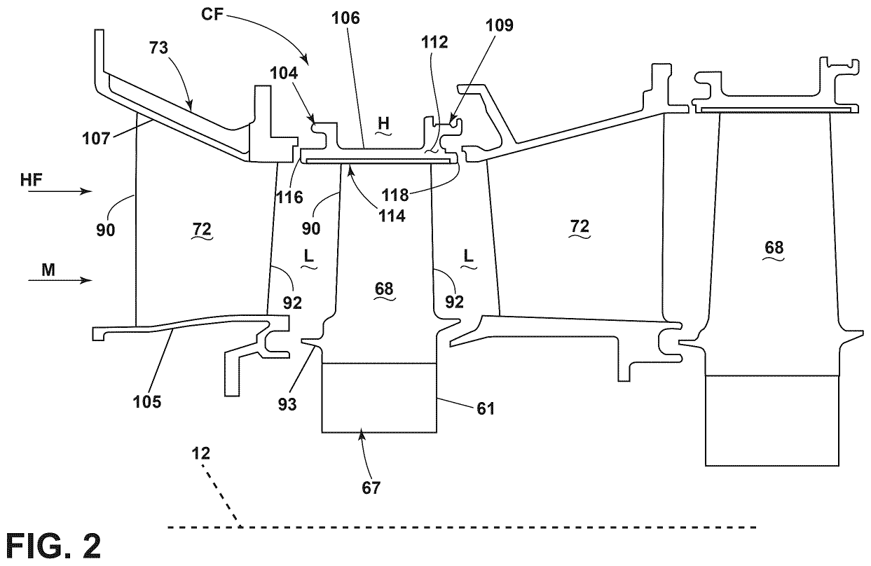

FIG. 2 illustrates the blade assembly 67 and the nozzle assembly 73 of the HP turbine 34 of FIG. 1. The blade assembly 67 includes the set of turbine blades 68 and the nozzle assembly 73 includes the set of static turbine vanes 72. Each turbine blade of the set of turbine blades 68 and each static turbine vane of the set of static turbine vanes 72 has a leading edge 90 and a trailing edge 92. The set of turbine blades 68 extend from a platform 93 connected to the disk 61. The set of static turbine vanes 72 extend radially between an inner band 105 and an outer band 107.

The shroud assembly 104 includes a set of shroud segments 109 in annular arrangement about the engine centerline 12 and positioned exterior (e.g., radially outward) of the set of turbine blades 68. Each shroud segment 106 has side faces 112 opposing and confronting side faces 112 of another shroud segment 106 of the set of shroud segments 109 when in annular arrangement. A mainstream flow path M is defined between the inner band 105, the outer band 107, the platform 93, and the shroud assembly 104. A spline seal 114 is provided at the side faces 112 to seal the mainstream flow path M between the adjacent segments of the set of shroud segments 109. That is, the spline seal 114 is disposed between the side faces 112 of adjacent shroud segments 106 to seal the adjacent segments to prevent air leakage. In a non-limiting example, the seal can include a W-seal, a C-seal, an E-seal, a U-seal, a bar seal, a rope seal, a damper element that secondarily functions as a seal, or a combination thereof. Each shroud segment 106 of the set of shroud segments 109 extends axially from a forward face 116 to an aft face 118. The set of shroud segments 109 at least partially separates a cooling air flow (CF) exterior of the mainstream flow path M from a hot air flow (HF) within the mainstream flow path M. That is, the cooling air flow (CF) is radially exterior of the set of shroud segments 109 and the hot air flow (HF) is radially interior of the set of shroud segments 109 with respect to the engine centerline 12.

In non-limiting examples, the shroud assembly 104, and the shroud segments 106 thereof, can have a circumferential to axial ratio of less than or equal to 10:1 and greater than or equal to 1:1, while greater and lesser ratios are contemplated. The circumferential to axial ratio can be defined as a ratio of the circumference of the shroud assembly 104 about the engine centerline 12 (at the mainstream flow path M) to axial length of the shroud assembly between the forward and aft faces 116, 118.

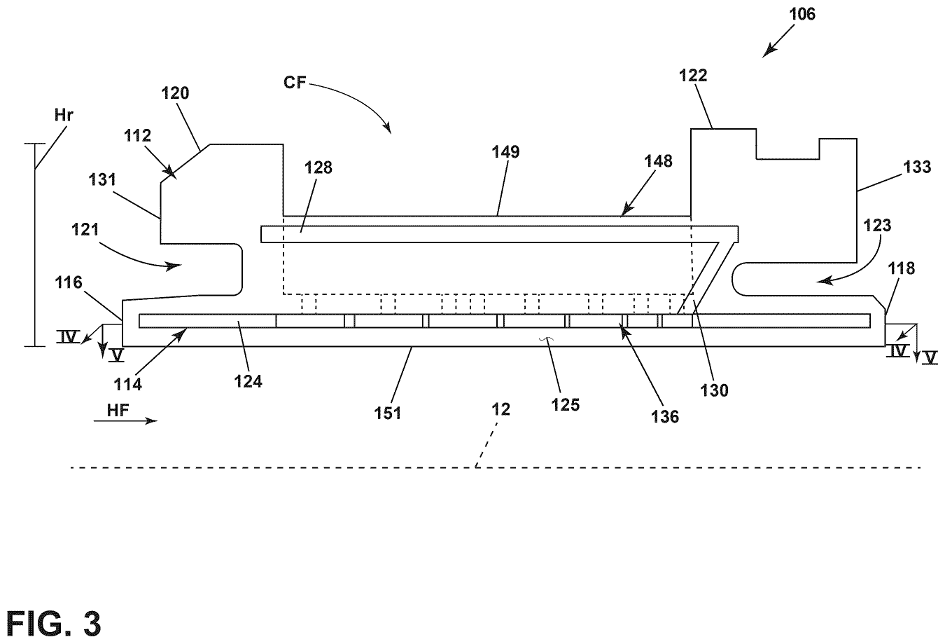

FIG. 3 is a schematic side view of the shroud assembly 104 showing one side face 112 of the shroud segment 106 of FIG. 2. While a one side face 112 is visible, it should be understood that the opposing side faces can be a mirror image of the illustrated side face 112 or complementary thereto.

The shroud segment 106 includes a body 148 with a cold side defining a cold surface 149 receiving the cooling air flow CF and a hot side defining a hot surface 151 confronting the hot air flow (HF). In a non-limiting example, any surface of the shroud segment 106 confronting the cooling air flow CF can define the cold surface 149. In a non-limiting example, any surface of the shroud segment 106 confronting the hot air flow (HF) can define the hot surface 151.

In a non-limiting example, a forward hanger 120 and an aft hanger 122 couple the shroud segment 106 to the core casing 46. The forward hanger 120 and the aft hanger 122 are located between a forward face 116 and an aft face 118. That is, the forward hanger 120 is spaced from the forward face 116 and the aft hanger 122 is spaced from the aft face 118. In another non-limiting example, the forward hanger 120 can extend past the forward face 116 and the aft hanger 122 can extend past the aft face 118. The forward hanger 120 defines a forward recess 121 for hanging the shroud segment 106 at a forward end 131 and the aft hanger 122 defines an aft recess 123 for hanging the shroud segment 106 at an aft end 133. In a non-limiting example, a radial thickness for the forward face 116 and the aft face 118 can be greater than or equal to 0.03 inches (0.76 millimeters) and less than or equal to 0.1 inches (2.54 millimeters), while smaller and larger thicknesses are contemplated. The maximum radial height (Hr) of the shroud segment 106, which can be defined between the forward hanger 120 and the hot surface 151 can be greater than or equal to 0.08 inches (2.03 millimeters) and less than or equal to 0.5 inches (12.7 millimeters), while larger and smaller heights are contemplated. These ranges provide for shroud segments 106 with thicknesses and size to withstand the temperature of the hot flow path (HF) while having a small enough thicknesses and size to maintain a weight benefit.

A first seal slot 124 is formed in a sealing surface 125. By way of a non-limiting example, the sealing surface 125 can be the side face 112. In a non-limiting example, the first seal slot 124 can be spaced from the hot surface 151 by greater than or equal to 0.02 inches (0.51 millimeters) and less than or equal to 0.04 inches (1.02 millimeters), while smaller and larger spacings are contemplated. Put another way, it is beneficial to have the spline seal 114 (FIG. 2) further away from the hot surface 151 to improve the longevity of the spline seal 114 by minimizing exposure to the high temperatures of the hot air flow HF. It is also beneficial to have the spline seal 114 close enough to the hot surface 151 to reduce the leakage of hot air from the hot flow path (HF). In this way, a balance can be struck between positioning the spline seal 114 far enough from the hot surface 151 to minimize heat exposure while near enough to mitigate hot air leakage between adjacent shroud segments 106. A second seal slot 128 is arranged within the side face 112 and is positioned radially exterior of the seal slot 124 relative to the engine centerline 12. A third seal slot 130 extends between the first seal slot 124 and the second seal slot 128. In a non-limiting example, the third seal slot 130 can be positioned near the aft face 118, while it is contemplated that the third seal slot 130 can be arranged anywhere within the sealing surface 125. Additional seals or seal slots can further mitigate hot air leaking between adjacent shroud segments 106, or to further seal areas where greater local pressures or leaks might otherwise occur. Furthermore, any positioning arrangement of the first, second, or third seal slots 124, 128, 130 is contemplated, and need not be limited as shown. Further still, any number of seal slots is contemplated, including one or more, which may or may not connect to one another along the sealing surface 125. A set of cooling apertures 136 are fluidly coupled to the first seal slot 124.

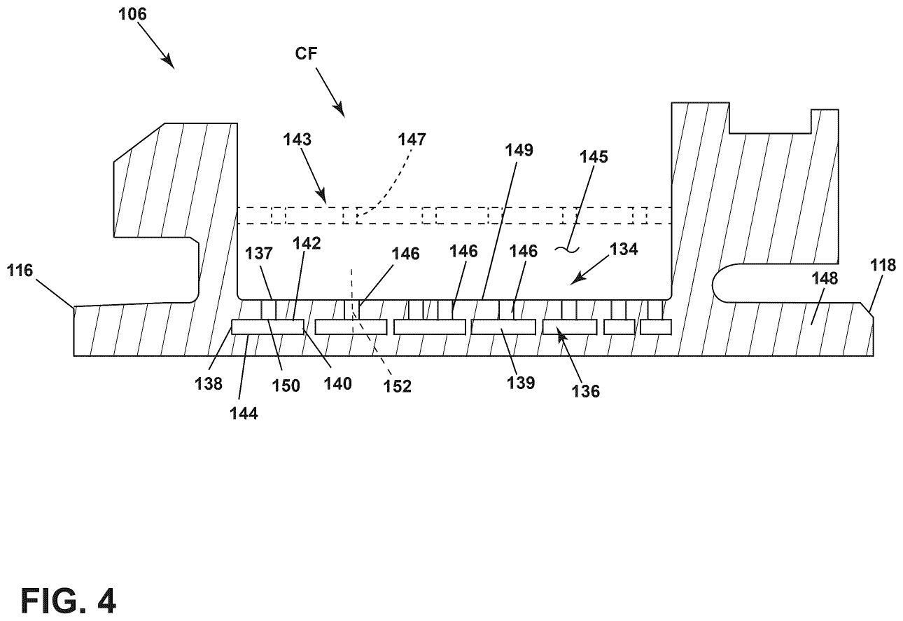

FIG. 4 is a schematic cross-sectional view of the shroud segment 106 taken along line IV-IV of FIG. 3. An air cooling circuit 134 provides the cooling flow CF from exterior of the shroud segment 106 through the body 148 to feed the set of multiple cooling apertures 136. The air cooling circuit 134 includes the set of cooling apertures 136 and a set of metering passages 146. The metering passages 146 fluidly couples the cooling flow CF to the set of multiple cooling apertures 136 through the body 148. Each cooling aperture of the set of cooling apertures 136 has at least one complementary metering passage of the set of metering passages 146. Each metering passage of the set of metering passages 146 extends between an inlet 137 and an outlet 150 exhausting to a corresponding cooling aperture of the set of cooling apertures 136. In a non-limiting example, one or more cooling apertures of the set of cooling apertures 136 is fed the cooling flow CF from two or more metering passages 146. Put another way, the air cooling circuit 134 is provided cooling flow CF via the metering passages 146 and cooling flow CF is provided to the set of cooling apertures 135 to exhaust to the spline seal 114 (FIG. 2).

Each cooling aperture of the set of cooling apertures 136 includes a cavity 139 at least partially defined between a first side 138 and a second side 140. In a non-limiting example, the first side 138 and the second side 140 can be confronting. Put another way, the first side 138 faces the second side 140 across the cavity 139. In another non-limiting example, the first side 138 and the second side 140 can be parallel, while an angled arrangement is contemplated. The cavity 139 is further defined between an upper surface 142 spaced from a lower surface 144 extending between the first side 138 and the second side 140. The outlet 150 for the set of metering passages 146 is positioned on the upper surface 142.

The metering passage 146 defines a metering passage centerline 152 as a longitudinal axis extending between the inlet 137 and the outlet 150. In a non-limiting example, the metering passage centerline 152 can be arranged orthogonal to the lower surface 144, while an angled or offset arrangement is contemplated. An orthogonal, angled, or offset arrangement provides for impinging the cooling flow CF on the lower surface to enhance local cooling. Non-limiting examples of angled arrangements include orienting the metering passage centerline 152 at angle relative to the lower surface 144, the upper surface 142, or both that is greater than or equal to 5 degrees (5°) and less than or equal to 45 degrees (45°), while wider ranges are contemplated. In another non-limiting example, it is contemplated that the metering passage 146 can be arranged to exhaust at the lower surface 144 to impinge upon the upper surface 142.

Optionally, the shroud segment 106 can include an impingement baffle 143 extending between the forward hanger 120 and the aft hanger 122 to define an intermediate cavity 145 of the air cooling circuit 134. A set of baffle passages 147 fluidly couples the cooling flow CF to the intermediate cavity 145 through the impingement baffle 143. The metering passages 146 fluidly couples cooling flow CF from the intermediate cavity 145 to the set of cooling apertures 136 through the impingement baffle 143. The impingement baffle 143 with the intermediate cavity 145 evenly supplies the cooling flow CF to the metering passages 146 to improve cooling to the spline seal 114 (FIG. 2). It is contemplated that, the air cooling circuit 134 includes the cooling flow CF, the set of baffle passages, the intermediate cavity 145, the metering passages 146, the cavity 139, and the seal slot 124.

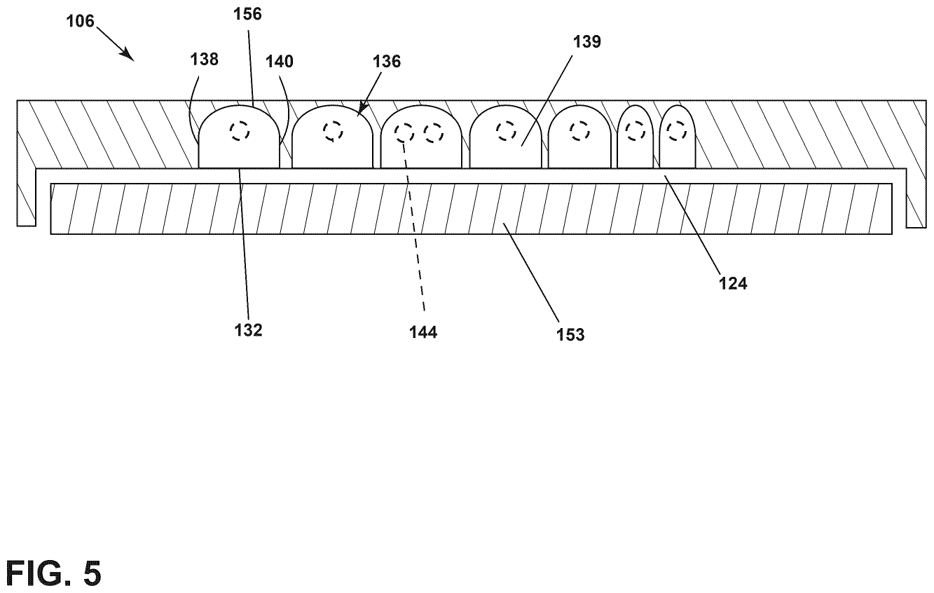

FIG. 5 is a schematic cross-sectional view of the shroud segment 106 taken along line V-V of FIG. 3 and includes a seal 153 partially positioned within the first seal slot 124. The cavity 139 for each cooling aperture of the set of cooling apertures 136 is further defined by a rear wall 156 extending between the first side 138 and the second side 140. In a non-limiting example, the rear wall 156 is curved so that the cavity 139 is shaped as a u-shaped cavity. However, it is contemplated that the rear wall 156 can have any shape, including but not limited to squared, rounded, elliptical, circular, rectangular, linear, curved, or combinations thereof. In another non-limiting example, the rear wall 156 is a closed rear wall. That is, the wide berth of the set of cooling apertures 136 defined by the u-shape of the cavity 139 provides local heat transfer along a wide area of the hot surface 151 (FIG. 3), as well as a feeding a wide area of the seal slot 124 which helps to mitigate leakage at the seal 153. Each cooling aperture of the set of cooling apertures 136 exhausts to the first seal slot 124 at an outlet 132 opposite of the rear wall 156.

In operation, the cooling flow (CF) is provided to the shroud segment 106 at the cold surface 149 (FIGS. 3 and 4). The cooling flow (CF) passes through the set of metering passages 146 and into the cavity 139 where the cooling flow (CF) impinges upon the lower surface 144. The body 148 at the hot surface 151 (FIG. 3) is heated by the hot air flow (HF) (FIG. 2), which is then cooled through heat transfer by impingement cooling with the cooling flow (CF) against the lower surface 144. The wide berth of the set of cooling apertures 136 defined by the u-shape of the cavity 139 provides local heat transfer along a wide area of the hot surface 151 (FIG. 3), while the impinging arrangement of the set of metering passages 146 enhances the cooling effect. The cooling flow (CF) exhausts from the set of cooling apertures 136 through the outlets 132 to the seal slot 124, which provides a purge flow to purge the air within the seal slot 124 and further pressurizes the seal slot 124 to prevent hot air ingestion from the hot air flow (HF) at the side face 112.

Benefits of the disclosure herein include reduction of local temperatures at the side face 112 and near the edges of the shroud segment 106, as well as temperature reduction at the spline seal between adjacent shroud segments 106 of the shroud assembly 104.

Additionally, a reduction of temperatures for the shroud assembly 104 along the hot surface 151 can be appreciated by the impingement of the cooling flow (CF) against the lower surface 144. Such a reduction in temperature increases and improves component durability and lifetime under high cycle fatigue, which reduces maintenance and related cost.

Additional benefits include purging the spline seal 114 and the edge gap between adjacent shroud segments 106 of the shroud assembly 104, as well as pressurizing the spline seal 114 and the edge gap to mitigate hot gas ingestion and improve overall engine efficiency.

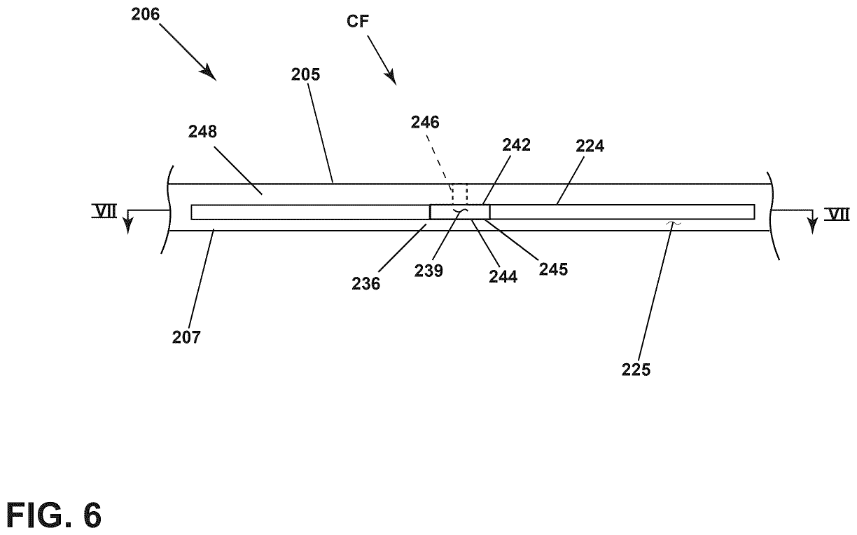

FIG. 6 is a schematic side view of a body 248 of a component 206, having a first surface 205 spaced from a second surface 207. In non-limiting examples, the first surface 205 can be a cold surface receiving a cooling flow CF and the second surface 207 can be a hot surface, such as a surface confronting combustion gases. A sealing surface 225, like a segment gap surface for a shroud assembly, extends between the first surface 205 and the second surface 207, while it is contemplated that the sealing surface 225 extends partially between either or both of the first and second surfaces 205, 207. In a non-limiting example, the sealing surface 225 is a trailing edge surface of a nozzle band. A seal slot 224 is provided in the sealing surface 225. In non-limiting examples, the component 206 can be any component utilizing a seal within a seal slot within a turbine engine, including but not limited to a shroud, a combustor, a heat shield, a nozzle, a blade, or a nozzle band.

A cooling aperture 236 is provided in the component 206 defining a cavity 239 visible through the seal slot 224. The cavity 239 is further defined between a first surface 242 and a second surface 244. The cooling aperture 236 can be positioned within the body 248 such that the second surface 244 is proximate the second surface 207, which can be greater than or equal to 0.02 inches (0.51 millimeters) and less than or equal to 0.04 inches (1.02 millimeters) in a non-limiting example, while smaller and larger spacings are contemplated. Such a proximate arrangement for the cooling aperture 236 can be near enough to the second surface 207 in order to provide effective heat transfer cooling away from the hot surface to cool the body 248.

A metering passage 246 extends through the body 248 to fluidly couple the cooling aperture 236 to the cooling flow CF through the body 248. The metering passage 246 exhausts at the first surface 242 to impinge upon the second surface 244 to define an impingement surface 245. In a non-limiting example, the impingement surface 245 is arranged parallel to the second surface 207. Impingement of the cooling flow CF against the impingement surface 245 provides heat transfer cooling away from the hot surface, provided by the proximate arrangement of the cooling aperture 236 to the hot surface.

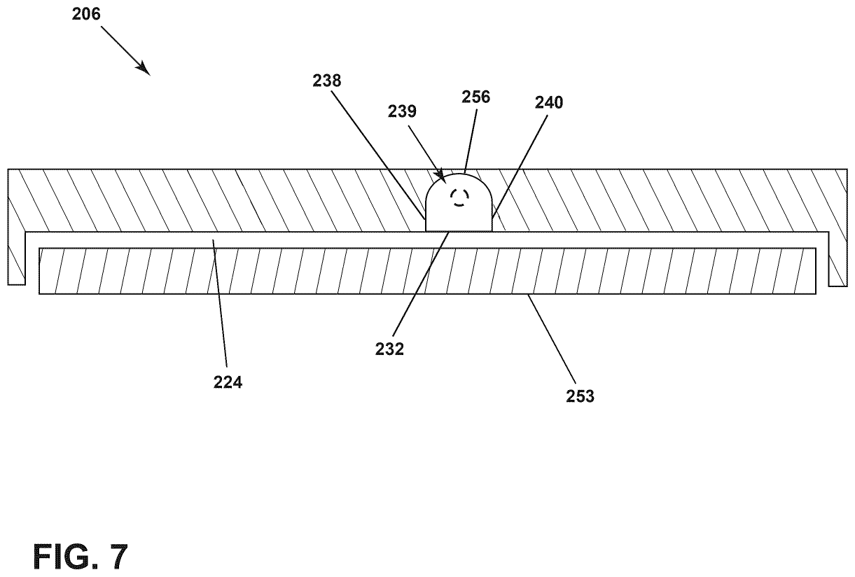

FIG. 7 is a schematic cross-sectional view of the component 206 taken along line VII-VII of FIG. 6, showing a closed rear end 256 for the cavity 239 that extends between a first side 238 and a second side 240. The cavity 239 exhausts to the seal slot 224 (shown with a seal 253) at an outlet 232 for the cavity 239 opposite of the closed rear end 256.

Benefits associated with the present disclosure include a component having at least one cooling aperture with an impingement surface which supplies cooling air to a component edge or a spline seal and seal slot. The supply of cooling air reduces the temperature of the component at the seal slot. The cooling aperture provides a reduction of local temperatures at the sealing surface 225 and impingement cooling for the hot surface. Such a reduction in temperature increases and improves component durability and lifetime under high cycle fatigue, which reduces maintenance and related cost. Additional benefits include purging the seal slot 224 as well as pressurizing the seal 253 to mitigate hot gas ingestion.

It should be appreciated that the different shroud segments, components, and their features as described among FIGS. 3-7 can be utilized within a common engine, such as the turbine engine 10 of FIG. 1, or within a common component contained therein, and it should be understood that the shroud segments, components, and their features are not mutually exclusive.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A gas turbine engine comprising: a compressor section, combustion section, and turbine section in serial flow arrangement and defining an engine core that is operationally separated into a rotor that rotates about a rotational axis and a stator that is stationary about the rotational axis; a shroud segment having a forward face and an aft face with a confronting side face extending between the forward face and the aft face; a seal slot provided in the confronting side face; a seal disposed within the seal slot; and an air cooling circuit located within the shroud segment and exhausting to the seal slot.

The gas turbine engine of any preceding clause, wherein the seal comprises a spline seal.

The gas turbine engine of any preceding clause, wherein the air cooling circuit comprises a first side spaced from and confronting a second side.

The gas turbine engine of any preceding clause, wherein the first side and the second side are in a parallel relationship.

The gas turbine engine of any preceding clause, further comprising a rear wall extending between the first side and the second side.

The gas turbine engine of any preceding clause, wherein the rear wall is curved.

The gas turbine engine of any preceding clause, wherein the air cooling circuit comprises a cavity and a metering passage having a metering passage outlet arranged at the cavity.

The gas turbine engine of any preceding clause, wherein the cavity is further defined between an upper surface and a lower surface, and wherein the metering passage outlet is arranged at the upper surface.

The gas turbine engine of any preceding clause, wherein the metering passage defines a metering passage centerline, and wherein the metering passage centerline is arranged orthogonal to the lower surface.

The gas turbine engine of any preceding clause, wherein the shroud segment further comprises a forward hanger and an aft hanger, and wherein the cooling aperture is positioned between the forward hanger and the aft hanger.

The gas turbine engine of any preceding clause, wherein an impingement baffle extends between the forward hanger and the aft hanger to define an intermediate cavity at least partially defining the air cooling circuit.

The gas turbine engine of any preceding clause, wherein air cooling circuit is defined by a set of cavities exhausting to the seal slot and defined by a set of metering passages exhausting to the set of cavities.

A component for a gas turbine engine, the component comprising: a body having a sealing surface with a seal slot formed into the sealing surface; an air cooling circuit arranged within the body, the air cooling circuit comprising: a cavity at least partially defined between a first side and a second side; and an outlet exhausting from the cavity and arranged at the seal slot.

The component of any preceding clause, wherein the body is one of a heat shield, a combustor, a shroud, a nozzle, a blade, or a nozzle band.

The component of any preceding clause, wherein cooling aperture is further defined by a closed rear end spaced from the outlet, the first side extended between the closed rear end and the outlet, and the second side, spaced from the first side, extending between the closed rear end and the outlet by the first side and the second side.

The component of any preceding clause, the component comprising: a body having a hot surface, a cold surface spaced from the hot surface, and a sealing surface; a cavity defined within the body and at least partially defined between a first side and a second side, and the cavity including an outlet exhausting at the sealing surface; an impingement surface at least partially defining the cavity and extending between the first side and the second side; and wherein the impingement surface is positioned proximate to the hot surface and spaced from the hot surface by the body.

The component of any preceding clause, wherein the impingement surface is arranged parallel to the hot surface.

The component of any preceding clause, further comprising a metering passage a metering passage outlet exhausting to the cavity at an upper surface opposite of the impingement surface.

The component of any preceding clause, wherein the sealing surface is a trailing edge surface of a nozzle band.

The component of any preceding clause, wherein the sealing surface further comprises a seal slot, and wherein the outlet exhausts at the seal slot.

1. A gas turbine engine comprising:
a compressor section, combustion section, and turbine section in serial flow arrangement and defining an engine core that is operationally separated into a rotor that rotates about a rotational axis and a stator that is stationary about the rotational axis;
a shroud segment having a forward face and an aft face with a confronting side face extending between the forward face and the aft face;
a seal slot provided in the confronting side face;
a seal disposed within the seal slot; and
an air cooling circuit located within the shroud segment and including a cavity defined between a first side and a second side, a rear wall extending between the first side and the second side, and an outlet arranged opposite the rear wall and opening to the seal slot, the air cooling circuit exhausting from the cavity through the outlet to the seal slot to purge air within the seal slot and pressurize the seal slot.

2. The gas turbine engine of claim 1, wherein the seal is a spline seal.

3. (canceled)

4. The gas turbine engine of claim 1, wherein the first side and the second side are arranged in a parallel relationship.

5. (canceled)

6. The gas turbine engine of claim 1, wherein the rear wall is curved.

7. The gas turbine engine of claim 1, wherein the air cooling circuit comprises a metering passage having a metering passage outlet arranged at the cavity.

8. The gas turbine engine of claim 7, wherein the cavity is further defined between an upper surface and a lower surface, and wherein the metering passage outlet is arranged at the upper surface.

9. The gas turbine engine of claim 8, wherein the metering passage defines a metering passage centerline, and wherein the metering passage centerline is arranged orthogonal to the lower surface.

10. The gas turbine engine of claim 1, wherein the shroud segment further comprises a forward hanger and an aft hanger, and wherein the air cooling circuit is positioned between the forward hanger and the aft hanger.

11. The gas turbine engine of claim 10, wherein an impingement baffle extends between the forward hanger and the aft hanger to define an intermediate cavity at least partially defining the air cooling circuit.

12. The gas turbine engine of claim 1, wherein the air cooling circuit is defined by a set of cavities exhausting to the seal slot and defined by a set of metering passages exhausting to the set of cavities.

13. A component for a gas turbine engine, the component comprising:
a body having a sealing surface with a seal slot formed into the sealing surface;
an air cooling circuit arranged within the body, the air cooling circuit comprising:
a cavity at least partially defined between a first side and a second side, and a rear wall extending between the first side and the second side; and
an outlet exhausting from the cavity and arranged at the seal slot opposite the rear wall to purge air within the seal slot and pressurize the seal slot.

14. The component of claim 13, wherein the body is one of a heat shield, a combustor, a shroud, a nozzle, a blade, or a nozzle band.

15. The component of claim 13, wherein the cavity is further defined by the rear wall is a closed rear end spaced from the outlet by the first side and the second side.

16. A component for a gas turbine engine, the component comprising:
a body having a hot surface, a cold surface spaced from the hot surface, and a sealing surface;
a cavity defined within the body and at least partially defined between a first side and a second side, a rear wall extending between the first side and the second side, and the cavity including an outlet exhausting at the sealing surface opposite the rear wall to purge air within the seal slot and pressurize the seal slot; and
an impingement surface at least partially defining the cavity and extending between the first side and the second side;
wherein the impingement surface is positioned proximate to the hot surface and spaced from the hot surface by the body.

17. The component of claim 16, wherein the impingement surface is arranged parallel to the hot surface.

18. The component of claim 16, further comprising a metering passage having a metering passage outlet exhausting to the cavity at an upper surface opposite of the impingement surface.

19. The component of claim 16, wherein the sealing surface is a trailing edge surface of a nozzle band.

20. The component of claim 16, wherein the sealing surface further comprises a seal slot, and wherein the outlet exhausts at the seal slot.
